(19) United States
(12) Patent Application Publication
(10) Pub. No.: US 2026/0244649 A1
(43) Pub. Date: Aug. 20, 2026

(54) NON-TRANSITORY COMPUTER READABLE MEDIUM AND DATA UPDATE APPARATUS

(71) Applicant: Honda Motor Co., Ltd., Tokyo (JP)

(72) Inventors: Naoki Mori, Tokyo (JP); Kazuma Ohara, Tokyo (JP)

(21) Appl. No.: 19/538,886

(22) Filed: Feb. 12, 2026

(30) Foreign Application Priority Data
Feb. 18, 2025 (JP) 2025-023982

(51) Int. Cl. G06F 16/29; G06F 3/06; G06F 8/65

(52) U.S. Cl. CPC G06F 16/29; G06F 3/065; G06F 8/65

(57) ABSTRACT

A data update program performs: acquiring point cloud data of an object surface around a moving body vehicle serving as a moving body obtained by a sensor mounted on the moving body at a predetermined cycle; generating control data to be used for movement control of the moving body by performing a transformation in which the point cloud data is transformed into a predetermined data format; storing the control data in a memory connected to the computer; and updating the control data stored in the memory based on new point cloud data acquired. The updating includes transforming the new point cloud data into the predetermined data format to generate new control data, and updating the control data stored in the memory based on the new control data.

### CROSS-REFERENCE TO RELATED APPLICATION

This application is based upon and claims the benefit of priority from Japanese Patent Application No. 2025-023982 filed on Feb. 18, 2025, the content of which is incorporated herein by reference.

### BACKGROUND

### Technical Field

The present invention relates to a non-transitory computer readable medium storing a data update program for updating map data and a moving control program, and to a data update apparatus.

### Related Art

Conventionally, a device configured to generate a Normal Distribution Transform (NDT) map by modeling a three-dimensional point cloud collected through a sensor such as a LiDAR with a normal distribution set is known (see e.g., Patent Literature 1). In the device described in JP 2021-176052 A, data included in the NDT map data is further processed to reduce the data size of the NDT map.

However, it is difficult to sufficiently reduce the memory consumption simply by processing the data included in the NDT map data as in the device described in JP 2021-176052 A.

### SUMMARY

An aspect of the present invention is a non-transitory computer-readable storage medium storing a data update program configured to be executed by a computer. The data update program causes the computer to perform: acquiring point cloud data of an object surface around a moving body vehicle serving as a moving body obtained by a sensor mounted on the moving body at a predetermined cycle; generating control data to be used for movement control of the moving body by performing a transformation in which the point cloud data is transformed into a predetermined data format; storing the control data in a memory connected to the computer; and updating the control data stored in the memory based on new point cloud data acquired. The updating includes transforming the new point cloud data into the predetermined data format to generate new control data, and updating the control data stored in the memory based on the new control data. The storage medium further stores a moving control program including the above data update program. The moving control program causes the computer to perform: performs movement control of the moving body based on the updated control data. The performing of the movement control includes performing the movement control based on the control data after the updating.

Another aspect of the present invention is a data update apparatus including a microprocessor and a memory connected to the microprocessor. The microprocessor is configured to perform: acquiring point cloud data of an object surface around a moving body vehicle serving as a moving body obtained by a sensor mounted on the moving body at a predetermined cycle; generating control data to be used for movement control of the moving body by performing a transformation in which the point cloud data is transformed into a predetermined data format; storing the control data in a memory connected to the computer; and updating the control data stored in the memory based on new point cloud data acquired. The microprocessor is configured to perform the updating includes transforming the new point cloud data into the predetermined data format to generate new control data, and updating the control data stored in the memory based on the new control data.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system according to an embodiment of the present invention;

FIG. 2 is a diagram for explaining NDT;

FIG. 3 is a block diagram illustrating a configuration of a main part of the vehicle control apparatus according to the embodiment of the present invention;

FIG. 4 is a flowchart illustrating an example of map update processing executed by the CPU of the controller in FIG. 3; and

FIG. 5 is a flowchart illustrating another example of map update processing executed by the CPU of the controller in FIG. 3.

### DETAILED DESCRIPTION

An embodiment of the invention will be described below with reference to the drawings. A data update apparatus according to an embodiment of the present invention is applicable to a vehicle having a self-driving capability, that is, a self-driving vehicle. Note that a vehicle to which the data update apparatus according to the present embodiment is applied may be referred to as a subject vehicle to be distinguished from other vehicles. The subject vehicle may be any of an engine vehicle having an internal combustion engine (engine) as a traveling drive source, an electric vehicle having a traveling motor as the traveling drive source, and a hybrid vehicle having an engine and a traveling motor as the traveling drive source. The subject vehicle can travel not only in a self-drive mode in which driving operation by a driver is unnecessary, but also in a manual drive mode with driving operation by the driver.

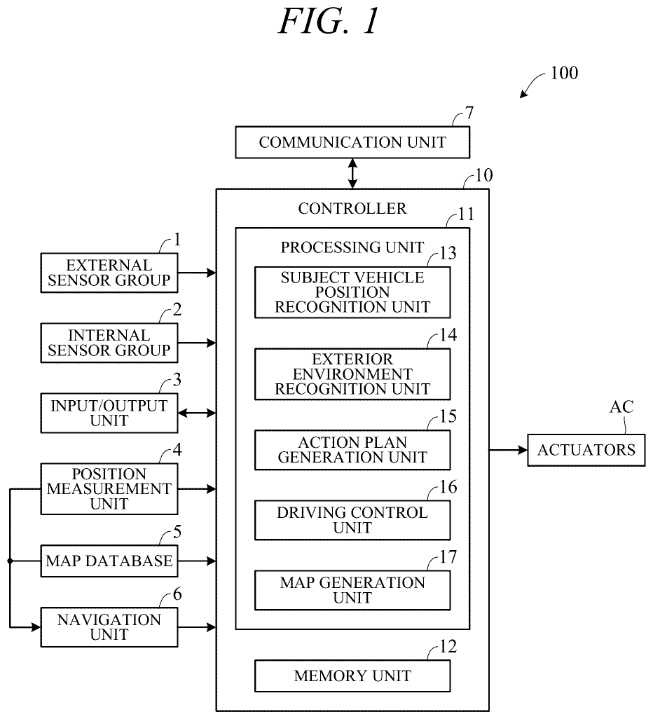

First, a schematic configuration of the subject vehicle related to self-driving will be described. FIG. 1 is a block diagram schematically illustrating an overall configuration of a vehicle control system 100 of the subject vehicle including the data update apparatus according to the present embodiment. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and traveling actuators AC each communicably connected to the controller 10.

The external sensor group 1 is a generic term for a plurality of sensors (external sensors) that detect an external situation which is peripheral information of the subject vehicle. For example, the external sensor group 1 includes a LiDAR that measures reflected light with respect to irradiation light in all directions of the subject vehicle and measures the distance from the subject vehicle to surrounding obstacles, a radar that detects other vehicles, obstacles, and the like around the subject vehicle by irradiating electromagnetic waves and detecting reflected waves, and a camera that is installed in the subject vehicle, has an imaging element (image sensor) such as a charge coupled device (CCD) or a complementary metal oxide semiconductor (CMOS), and captures images of the surrounding (front, rear, and side) of the subject vehicle.

The internal sensor group 2 is a generic term for a plurality of sensors (internal sensors) that detect a traveling state of the subject vehicle. For example, the internal sensor group 2 includes an inertial measurement unit (IM) or the like that detects rotational angular velocity around three axes in a vertical direction at the center of gravity of the subject vehicle, a front-rear direction (advancing direction) of the subject vehicle, and a lateral direction (vehicle-width direction) of the subject vehicle, and accelerations in the directions of three axes. The internal sensor group 2 also includes a sensor that detects a driver's driving operation in the manual drive mode, for example, an operation of an accelerator pedal, an operation of a brake pedal, an operation of a steering wheel, or the like.

The input/output device 3 is a generic term for devices to which a command is input from the driver or information is output to the driver. For example, the input/output device 3 includes various switches to which the driver inputs various commands by operating an operation member, a microphone to which the driver inputs a command by voice, a display that provides information to the driver via a display image, and a speaker that provides information to the driver by voice.

The position measurement unit (global navigation satellite system (GNSS) unit) 4 has a positioning sensor that receives a positioning signal transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information used for the navigation unit 6, and includes, for example, a hard disk or a semiconductor element. The map information includes road position information, information on a road shape (curvature or the like), and position information on intersections and branch points. The map information stored in the map database 5 is different from high-precision map information stored in the memory unit 12 of the controller 10.

The navigation unit 6 is a device that searches for a target route to a destination on a road which is entered by a driver and guides the driver along the target route. The input of the destination and the guidance along the target route are performed via the input/output device 3. The target route is calculated on the basis of a current position of the subject vehicle measured by the position measurement unit 4 and the map information stored in the map database 5. The current position of the subject vehicle can be measured using the detection values of the external sensor group 1, and the target route may be calculated on the basis of the current position and the high-precision map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for each of predetermined management areas, for example, a wireless LAN, Wi-Fi (registered trademark), Bluetooth (registered trademark), and the like. The acquired map information is output to the map database 5 and the memory unit 12, and the map information is updated.

The actuators AC are traveling actuators for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuators AC include a brake actuator that operates the braking device in the subject vehicle and a steering actuator that drives the steering device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits (not illustrated) such as an I/O interface. Although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly precise detailed map information (referred to as high-precision map information). The high-precision map information includes information on the position of roads, road geometry (curvature and others), road gradients, positions of intersections and junctions, types and positions of road division lines such as white lines, number of lanes, lane width and position of each lane (center position of lanes and boundaries of lane positions), positions of landmarks (buildings, traffic lights, signs, and others) on maps, and road surface profiles such as road surface irregularities. In the embodiment, center lines, lane lines, outside lines, and the like are collectively referred to as road division lines. The high-precision map information stored in the memory unit 12 includes map information (referred to as external map information) that has been acquired from the outside of the subject vehicle via the communication unit 7, and a map (referred to as internal map information) created by the subject vehicle itself using detection values by the external sensor group 1 or detection values of the external sensor group 1 and the internal sensor group 2.

The external map information is, for example, information of a map that has been acquired via a cloud server (referred to as a cloud map), and the internal map information is, for example, information of a map (referred to as an environmental map) including three-dimensional point cloud data generated by mapping using a technology such as simultaneous localization and mapping (SLAM), for example. The external map information is shared among the subject vehicle and other vehicles, whereas the internal map information is map information that is exclusive to the subject vehicle (for example, map information that the subject vehicle owns by itself). For roads on which the subject vehicle has never traveled, newly constructed roads, and the like, environmental maps are created by the subject vehicle itself. Note that the internal map information may be provided to a server device or other vehicles via the communication unit 7. In addition to the above-described high-precision map information, the memory unit 12 also stores traveling trajectory information of the subject vehicle, various control programs, and thresholds for use in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes (or estimates) the position (subject vehicle position) of the subject vehicle on a map, on the basis of the position information of the subject vehicle, obtained by the position measurement unit 4, and the map information of the map database 5. The subject vehicle position may be recognized (estimated) using the high-precision map information stored in the memory unit 12 and the peripheral information of the subject vehicle detected by the external sensor group 1, whereby the subject vehicle position can be recognized with high accuracy. The movement information (moving direction, moving distance) of the subject vehicle may be calculated on the basis of the detection values by the internal sensor group 2, and the subject vehicle position may be recognized accordingly. When the subject vehicle position can be measured by a sensor installed on a road or outside a road side, the subject vehicle position can be recognized by communicating with the sensor via the communication unit 7.

The exterior environment recognition unit 14 recognizes an external situation around the subject vehicle on the basis of signals from the external sensor group 1 such as the LiDAR, the radar, and the camera. For example, the position, speed, and acceleration of a surrounding vehicle (a forward vehicle or a rearward vehicle) traveling around the subject vehicle, the position of a surrounding vehicle stopped or parked around the subject vehicle, the positions and states of other objects, and the like are recognized. Other objects include signs, traffic lights, markings such as division lines and stop lines of roads, buildings, guardrails, utility poles, signboards, pedestrians, bicycles, and the like. The states of other objects include a color (red, green, yellow) of a traffic light, and the moving speed and direction of a pedestrian or a bicycle. A part of the stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current point of time to a predetermined time ahead on the basis of, for example, the target route calculated by the navigation unit 6, the high-precision map information stored in the memory unit 12, the subject vehicle position recognized by the subject vehicle position recognition unit 13, and the external situation recognized by the exterior environment recognition unit 14. When there is a plurality of paths that are candidates for the target path on the target route, the action plan generation unit 15 selects, from among the plurality of paths, an optimal path that satisfies criteria such as compliance with laws and regulations, and efficient and safe traveling, and sets the selected path as the target path. Then, the action plan generation unit 15 generates an action plan corresponding to the generated target path. The action plan generation unit 15 generates various action plans corresponding to passing traveling for passing a preceding vehicle, lane change traveling for changing a travel lane, tracking traveling for tracking a preceding vehicle, lane keeping traveling for keeping a lane without departing from a travel lane, deceleration traveling or acceleration traveling, and the like. When the target path is generated, first, the action plan generation unit 15 determines a travel mode, and then generates the target path on the basis of the travel mode.

In the self-drive mode, the driving control unit 16 controls each of the actuators AC such that the subject vehicle travels along the target path generated by the action plan generation unit 15. More specifically, the driving control unit 16 calculates a requested drive force for obtaining target acceleration for each unit time calculated by the action plan generation unit 15 in consideration of traveling resistance determined according to a road gradient or the like in the self-drive mode. Then, for example, the actuators AC are feedback controlled so that an actual acceleration detected by the internal sensor group 2 becomes the target acceleration. More specifically, the actuators AC are controlled so that the subject vehicle travels at a target vehicle speed and the target acceleration. In the manual drive mode, the driving control unit 16 controls each of the actuators AC in accordance with a travel command (steering operation or the like) from the driver acquired by the internal sensor group 2.

The map generation unit 17 generates an environmental map in the surroundings of the road on which the subject vehicle has traveled, as internal map information, by using the detection values that have been detected by the external sensor group 1 while the subject vehicle is traveling in the manual drive mode. For example, an edge indicating an outline of an object or a characteristic region (blob) is extracted from a plurality of frames of camera images that have been acquired by the camera, on the basis of luminance and color information for each of pixels, and feature points are extracted with use of such edge or blob information. The feature points are, for example, intersections of edges, and correspond to corners of buildings, corners of road signs, or the like. The map generation unit 17 calculates a three-dimensional position of a feature point while estimating the position and posture of the camera so that identical feature points converge on a single point in a plurality of frames of camera images, in accordance with the algorithm of the SLAM technology. By performing this calculation processing for each of the plurality of feature points, an environmental map including the three-dimensional point cloud data is generated. Note that the environmental map may be generated by extracting feature points of objects around the subject vehicle using data acquired by a radar or LiDAR instead of a camera.

The subject vehicle position recognition unit 13 may perform subject vehicle position recognition processing on the basis of the environmental map generated by the map generation unit 17 and the feature points that have been extracted from the camera image. In addition, the subject vehicle position recognition unit 13 may perform the subject vehicle position recognition processing in parallel with the map creation processing by the map generation unit 17. The map creation processing and the position recognition (estimation) processing are simultaneously performed in accordance with the algorithm of the SLAM technology. The map generation unit 17 is capable of generating the environmental map not only when traveling in the manual drive mode but also when traveling in the self-drive mode. In a case where the environmental map has already been generated and stored in the memory unit 12, the map generation unit 17 may update the environmental map, on the basis of a newly extracted feature point from a newly acquired camera image.

Meanwhile, as one method of reducing the data size of the environmental map (point cloud data), there is a method of performing normal distribution transform (NDT) on the environmental map, that is, a method of transforming the environmental map into an NDT map. The NDT map is obtained by dividing an environmental map including three-dimensional point cloud data into grids of a predetermined size and approximating the distribution of the point cloud in each grid with normal distribution (average vector and covariance matrix).

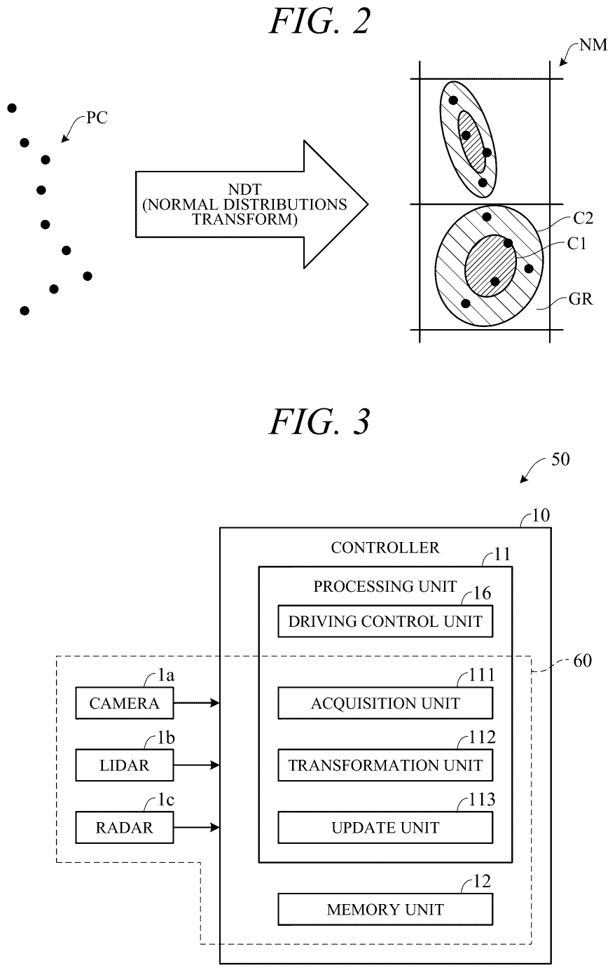

FIG. 2 is a diagram for explaining the NDT. On the left side of FIG. 2, a point cloud PC that is a part of the environmental map is schematically illustrated. On the right side of FIG. 2, an NDT map NM obtained by performing normal distribution transform on the point cloud PC is schematically illustrated. Note that, in the figure, the point cloud PC of the transformation source is drawn in a superimposed manner on the NDT map NM for the sake of easy understanding of the description. The rectangular region GR divided by the grid represents a grid in the NDT map, and the centers of the ellipses C1 and C2 in the grid represent the center (average value) of the distribution of the point cloud in the grid. The ellipse C1 schematically represents the vicinity of the center of the distribution of the point cloud, and the ellipse C2 schematically represents the spread of the distribution of the point cloud.

The data size of the map can be reduced by transforming the environmental map into the NDT map as shown in FIG. 2. On the other hand, when the NDT map is updated with the newly acquired point cloud data, the point cloud data obtained by combining the newly acquired point cloud data and the point cloud data used to generate the NDT map is subjected to normal distribution transform, and the updated NDT map is generated. That is, the update of the NDT map requires the point cloud data used to generate the NDT map.

Therefore, when the environmental map is transformed into the NDT map, it is necessary to hold the environmental map (point cloud data) that is the transformation source of the NDT map in preparation for subsequent map update. Therefore, the memory consumption cannot be sufficiently reduced only by transforming the environmental map into the NDT map. Therefore, in order to handle such a problem, the data update apparatus (hereinafter also referred to as a map update apparatus) according to the present embodiment is configured as follows.

FIG. 3 is a block diagram illustrating a configuration of a main part of the vehicle control apparatus 50 according to the present embodiment. The vehicle control apparatus 50 constitutes a part of the vehicle control system 100 in FIG. 1. As illustrated in FIG. 3, the vehicle control apparatus 50 includes a controller 10, a camera 1a, a LiDAR 1b, and a radar 1c. In addition, the vehicle control apparatus 50 includes a map update apparatus 60 constituting a part of the vehicle control apparatus 50. The map update apparatus 60 updates map data used for driving control of the subject vehicle based on detection data (camera image) of the camera 1a.

The camera 1a is a monocular camera including an imaging element (image sensor) such as a CCD or a CMOS, and constitutes a part of the external sensor group 1 in FIG. 1. The camera 1a detects a situation around the subject vehicle. The camera 1a is attached to, for example, a predetermined position in a front part of the subject vehicle, continuously images a space ahead of the subject vehicle at a predetermined frame rate, and sequentially outputs frame image data (camera images) serving as detection information to the controller 10. Note that the camera 1a may be a stereo camera.

The LiDAR 1b is mounted on the subject vehicle, measures scattered light with respect to irradiation light in all directions of the subject vehicle, and detects a distance from the subject vehicle to an obstacle in the surroundings. The LiDAR 1b outputs the detection value (detection data) to the controller 10. The radar 1c is mounted on the subject vehicle and detects other vehicles, obstacles, and the like around the subject vehicle by emitting electromagnetic waves and detecting reflected waves. The radar 1c outputs the detection value (detection data) to the controller 10.

The controller 10 includes a processing unit 11 and a memory unit 12. The processing unit 11 includes, as functional configurations, an acquisition unit 111, a transformation unit 112, an update unit 113, and a driving control unit 16.

Note that the acquisition unit 111, the transformation unit 112, and the update unit 113 are configured by, for example, the map generation unit 17 in FIG. 1. In addition, the acquisition unit 111, the transformation unit 112, the update unit 113, the camera 1a, the LiDAR 1b, the radar 1c, and the memory unit 12 are included in the map update apparatus 60.

The acquisition unit 111 acquires a camera image from the camera 1a at a predetermined cycle while the subject vehicle is traveling. The acquisition unit 111 extracts feature points from the acquired camera image. As a result, the point cloud data of the object surface around the subject vehicle is acquired.

The transformation unit 112 transforms the point cloud data acquired by the acquisition unit 111 into a predetermined data format. More specifically, the transformation unit 112 applies processing of approximating a normal distribution function, so-called NDT, to the point cloud data to transform the point cloud data into an NDT map. The transformation unit 112 stores the NDT map in the memory unit 12. In this manner, the NDT map corresponding to the driving position of the subject vehicle is generated and stored in the memory unit 12. This processing by the transformation unit 112 is executed at a predetermined cycle while the subject vehicle is traveling, so that the NDT map corresponding to the road on which the subject vehicle has traveled is generated and stored in the memory unit 12.

When new point cloud data is acquired by the acquisition unit 111, the update unit 113 updates the NDT map stored in the memory unit 12 based on the new point cloud data. Specifically, the update unit 113 first applies the NDT to the new point cloud data acquired by the acquisition unit 111 to generate a new NDT map (hereinafter referred to as a new NDT map) corresponding to the present driving position of the subject vehicle. Next, the update unit 113 updates information related to a region (hereinafter referred to as a target region) corresponding to the present driving position in the NDT map (hereinafter referred to as an existing NDT map) stored in the memory unit 12 based on the new NDT map. The target region corresponds to the present imaging range of the camera 1a.

Here, updating of the existing NDT map will be described. The update unit 113 updates the information of the target region of the existing NDT map in units of grids. First, the update unit 113 updates the average vector of the grid to be updated (hereinafter referred to as a target grid). The following Formula (i) is an update formula of the x component of the average vector.

$$\overline{{x}_{n}} = \frac{n - 1}{n} \overline{{x}_{n - 1}} + \frac{1}{n} {x}_{n} \qquad ( i )$$

In Formula (i), n is the number of updates of the NDT map of this time. xn is an x component of an average vector of the grid (hereinafter referred to as a corresponding grid) corresponding to the target grid in the new NDT map. xn—represents a current value of the x component of the average vector of the target grid in the existing NDT map, that is, a value after the n-th map update. xn-1—represents a previous value of the x component of the average vector of the target grid in the existing NDT map, that is, a value after the n-1-th map update.

The update unit 113 calculates a current value of the x component of the average vector of the target grid by performing weighted averaging on the previous value of the x component of the average vector of the target grid and the x component of the average vector of the corresponding grid based on the number of updates as shown in the above Formula (i). The update unit 113 similarly calculates current values of the y component and the z component of the average vector of the target grid. As a result, each of the xyz components of the average vector of the target grid is updated. In this manner, the update unit 113 updates the average vector of the target grid in the existing NDT map by the number of updates, the previous value of the average vector of the target grid, and the average vector of the corresponding grid in the new NDT map. As a result, the update can be performed only with the number of updates, the previous value of the average vector, and the numerical value of the average vector, and the point cloud data up to the previous time does not need to be used, so that the necessary memory can be reduced.

Next, the update unit 113 updates the covariance matrix of the target grid. The following Formula (ii) is a formula representing a covariance matrix of the target grid. The following Formula (iii) is an update formula of the xy component of the covariance matrix in the target grid.

$${cov}_{n} = ( \begin{matrix}{s}_{xx}^{n} & {s}_{xy}^{n} & {s}_{xz}^{n} \\ {s}_{xy}^{n} & {s}_{yy}^{n} & {s}_{yz}^{n} \\ {s}_{xz}^{n} & {s}_{yz}^{n} & {s}_{zz}^{n}\end{matrix} ) \qquad ( ii )$$

$${s}_{x y}^{n} = \frac{n - 1}{{n}^{2}} ( {x}_{n} - \overline{{x}_{n - 1}} ) ( {y}_{n} - \overline{{y}_{n - 1}} ) + \frac{n - 1}{n} {s}_{x y}^{n - 1} \qquad ( iii )$$

In Formulas (ii) and (iii), n is the number of updates. xn and yn are x and y components of the average vector of the corresponding grid in the new NDT map. Sxy, Sxz, and Syz represent covariances of an xy component, an xz component, and a yz component, respectively. Sxx, Syy, and Szz represent dispersions of an x component, a y component, and a z component, respectively. Sn represents a current value, that is, a value after the n-th map update. Sn-1 represents a previous value, that is, a value after n-1-th map update.

The update unit 113 calculates the current value of the xy component of the covariance matrix of the target grid using the above Formula (iii). The update unit 113 similarly calculates current values of other components (components other than the xy component) of the covariance matrix. As a result, the covariance matrix of the target grid is updated. In this manner, the update unit 113 updates the covariance matrix of the target grid in the existing NDT map by the number of updates, the previous value of the average vector and the previous value of the covariance matrix in the target grid, and the average vector of the corresponding grid in the new NDT map. As a result, since it is not necessary to use the point cloud data up to the previous time, the necessary memory can be reduced.

The update unit 113 executes the average vector update processing using the above Formula (i) and the covariance matrix update processing using the above Formula (iii) on each grid in the target region of the existing NDT map.

Note that when executing the update processing, the update unit 113 calculates a divergence degree from the new NDT map for each grid in the target region of the existing NDT map. Then, the update unit 113 adjusts the coefficient (the number of updates n) used in the above Formulas (i) and (iii) so as to increase the degree of influence of the new NDT map on the updated existing NDT map with respect to the grid whose divergence degree is equal to or greater than a predetermined degree. Specifically, a value smaller than the actual value is substituted for the number of updates n. Note that the predetermined degree, which is a criterion for determining whether there is a divergence from the new NDT map, may be determined based on the variance of the following Formula (iv).

$$f ( v ) = \frac{1}{{( 2 π )}^{k / 2} \vert Σ {\vert}^{1 / 2}} exp ( - \frac{1}{2} {( ν - μ )}^{T} {Σ}^{- 1} ( v - μ ) ) \qquad ( iv )$$

In Formula (iv), X is a covariance matrix of the target grid of the existing NDT map. μ is an average vector of target grids of the existing NDT map. v is an average vector of the corresponding grids in the new NDT map. Note that the method of calculating the likelihood using the above Formula (iv) is an example, and the likelihood may be calculated by other methods.

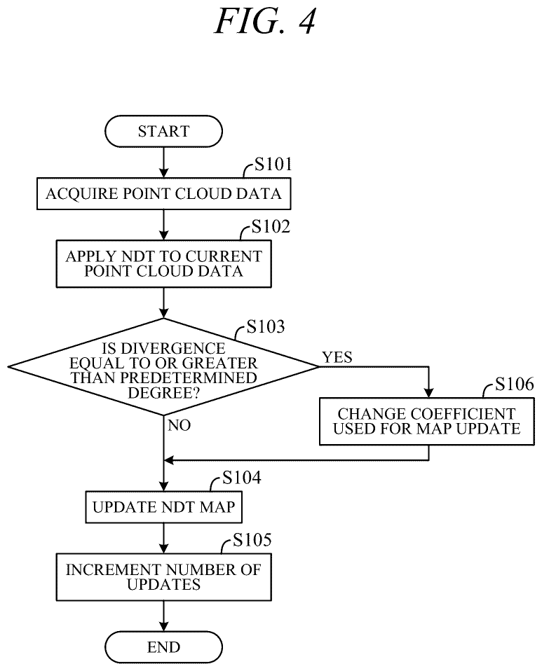

FIG. 4 is a flowchart illustrating an example of map update processing executed by the CPU of the controller 10 in FIG. 3 according to a predetermined program.

The processing illustrated in this flowchart is started when the vehicle control system 100 is activated, and is repeated at a predetermined cycle while the vehicle control system 100 is activated. Specifically, the processing is repeated every time the camera image is input from the camera 1a, that is, at a time interval defined by the frame rate of the camera 1a. Note that the predetermined cycle may be variable instead of being constant in consideration of necessity for traffic safety, calculation load, and the like.

First, in step S101, when a camera image is input from the camera 1a, the controller 10 extracts feature points (point cloud data) from the camera image. In step S102, the controller 10 applies the NDT to the point cloud data acquired in step S101. As a result, an NDT map corresponding to the point cloud data acquired in step S101 is generated. In step S103, the controller 10 determines whether or not the divergence degree between the NDT map (existing NDT map) stored in the memory unit 12 and the NDT map (new NDT map) generated in step S102 is equal to or greater than a predetermined degree.

When the determination in step S103 is negative, in step S104, the controller 10 updates the existing NDT map based on the new NDT map using the above Formulas (i) and (iii). In step S105, the controller 10 increments the number of updates n by 1.

On the other hand, when the determination in step S103 is affirmative, in step S106, the controller 10 substitutes a value smaller than the actual value into the number of updates n used in the above Formulas (i) and (iii), and proceeds to step S104. As a result, the map update in which the weight of the new NDT map is made larger is performed.

Note that the processing of steps S103 to S106 is executed for each grid with respect to a region (target region) corresponding to the imaging range of the camera image input in step S101 in the existing NDT map (the NDT map stored in the memory unit 12).

In addition, in the existing NDT map, update information indicating the number of updates n is stored for each grid.

According to the above-described embodiment, the following effects can be obtained.
(1) A map update apparatus 60 includes an acquisition unit 111 configured to acquire point cloud data of an object surface around a subject vehicle serving as a moving body obtained by a camera 1a mounted on the subject vehicle at a predetermined cycle, a transformation unit 112 configured to transform the point cloud data acquired by the acquisition unit 111 into a predetermined data format and generate map data serving as control data to be used for movement control of the subject vehicle, a memory unit 12 configured to store the map data generated by the transformation unit 112, and an update unit 113 configured to update the map data stored in the memory unit 12 based on new point cloud data acquired by the acquisition unit 111. The update unit 113 transforms the new point cloud data into a predetermined data format to generate new map data (new NDT map), and updates the map data (existing NDT map) stored in the memory unit 12 based on the new map data. The transformation by the transformation unit 112 is a normal distribution transform (NDT) that approximates the point cloud data to a normal distribution function.

In this manner, the memory consumption can be reduced by holding the map used for the driving control of the vehicle as the NDT map. In addition, with the above configuration, the NDT map can be updated without using the point cloud data of the transformation source of the NDT map. As a result, there is no need to hold the point cloud data of the transformation source, and the memory consumption can be further reduced.
(2) The update unit 113 counts the number of times the map data stored in the memory unit 12 has been updated, and updates the map data stored in the memory unit 12 with new map data weighted based on the number of updates. More specifically, the update unit 113 counts the number of times the map data stored in the memory unit 12 has been updated, performs weighted averaging on the new map data and the map data stored in the memory unit 12 based on the number of updates, and updates the map data stored in the memory unit 12. As a result, the accuracy of the map data is improved each time the map data is updated.
(3) When weighting the new map data and the map data stored in the memory unit 12 based on the number of updates, the update unit 113 increases the weight of the new map data in a case where a divergence degree between the new map data and the map stored in the memory unit 12 is equal to or greater than a predetermined degree. As a result, map update is performed with priority given to information of the new map data, and in a case where a road or an environment around the road greatly changes due to road construction or the like, the map data can be appropriately updated so as to correspond to the latest road situation.
(4) When the map data is updated by the update unit 113, the driving control unit 16 performs movement control (driving control) of the subject vehicle based on the updated map data. More specifically, when the map data is updated by the update unit 113, the action plan generation unit 15 generates a target path based on the updated map data, and the driving control unit 16 controls each actuator AC so that the subject vehicle travels along the target path.

The above embodiment may be modified into various embodiments. Hereinafter, modified examples will be described. In the above embodiment, the acquisition unit 111 acquires the detection data (camera image) of the camera 1a serving as the in-vehicle sensor. However, the in-vehicle sensor may be other than the camera 1a, and the acquisition unit may acquire detection data of the LiDAR 1b or the radar 1c at a predetermined cycle and extract feature points from the detection data.

In addition, in the above embodiment, when the existing NDT map is updated by performing weighted averaging with the new NDT map, the weight of the new NDT map is increased in a case where the divergence degree between the existing NDT map and the new NDT map is equal to or greater than a predetermined degree. More specifically, a value smaller than the actual value is substituted into the number of updates n used in the above Formulas (i) and (iii) (S106).

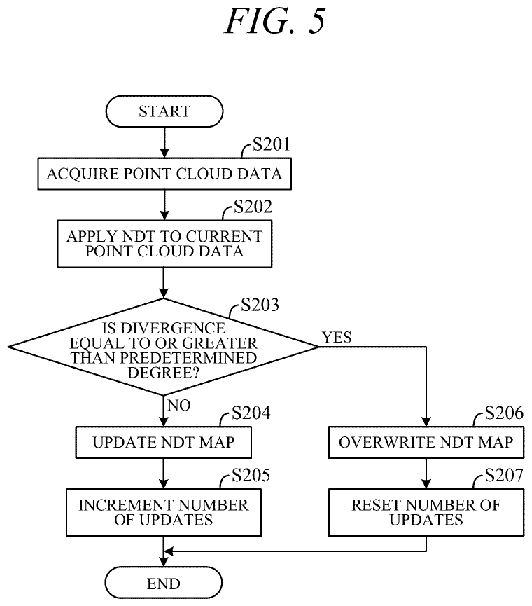

However, the method of updating the NDT map is not limited thereto. FIG. 5 is a flowchart illustrating another example of map update processing executed by the CPU of the controller 10 in FIG. 3 according to a predetermined program. As illustrated in FIG. 5, when the divergence degree between the existing NDT map and the new NDT map is equal to or greater than a predetermined degree, the controller 10 may replace the existing NDT map with the new NDT map in step S206. That is, the existing NDT map may be overwritten by the new NDT map. Then, in step S207, the controller 10 may reset the number of updates n to 0 and end the processing. Note that steps S201 to S205 in FIG. 5 are similar to steps S101 to S105 in FIG. 4, and thus description thereof will be omitted.

Furthermore, in the above embodiment, the vehicle control apparatus 50 and the map update apparatus 60 are applied to the self-driving vehicle, but the vehicle control apparatus 50 and the map update apparatus 60 are also applicable to vehicles other than the self-driving vehicle. For example, the vehicle control apparatus 50 and the map update apparatus 60 can also be applied to a manual driving vehicle including Advanced driver-assistance systems (ADAS).

Furthermore, in the above embodiment, the case where the processing illustrated in FIGS. 4 and 5 is executed by the controller 10 in FIG. 3 has been described by way of an example. However, the processing illustrated in FIGS. 4 and 5 may be executed by a communication terminal such as a smartphone or an external server device. Specifically, a program for causing the processing illustrated in FIGS. 4 and 5 to be executed may be supplied to a communication terminal such as a smartphone or an external server device, and a controller included in the smartphone or the like may execute the supplied program. That is, the controller included in the smartphone or the like may have the functional configuration of FIG. 3.

The above embodiment can be combined as desired with one or more of the aforesaid modifications. The modifications can also be combined with one another.

According to the present invention, it is possible to suppress an increase in memory consumption involved in the map update.

Above, while the present invention has been described with reference to the preferred embodiments thereof, it will be understood, by those skilled in the art, that various changes and modifications may be made thereto without departing from the scope of the appended claims.

What is claimed is:

1. A non-transitory computer-readable storage medium storing a data update program configured to be executed by a computer, wherein
the data update program causes the computer to perform:
acquiring point cloud data of an object surface around a moving body obtained by a sensor mounted on the moving body at a predetermined cycle;
generating control data to be used for movement control of the moving body by performing a transformation in which the point cloud data is transformed into a predetermined data format;
storing the control data in a memory connected to the computer; and
updating the control data stored in the memory based on new point cloud data acquired, wherein
the updating includes transforming the new point cloud data into the predetermined data format to generate new control data, and updating the control data stored in the memory based on the new control data.

2. The storage medium according to claim 1, wherein
the updating includes counting the number of times the control data stored in the memory has been updated, and updating the control data stored in the memory with the new control data weighted based on the number of times counted.

3. The storage medium according to claim 1, wherein
the updating includes counting the number of times the control data stored in the memory has been updated, performing weighted averaging on the new control data and the control data stored in the memory based on the number of updates counted, and updating the control data stored in the memory.

4. The storage medium according to claim 1, wherein
the updating includes:
updating the control data stored in the memory by performing weighting on the new control data and the control data stored in the memory; and
when updating the control data, in a case where a divergence degree between the new control data and the control data stored in the memory is equal to or greater than a predetermined degree, increasing a weight of the new control data.

5. The storage medium according to claim 1, wherein
the updating includes, in a case where a divergence degree between the new control data and the control data stored in the memory is equal to or greater than a predetermined degree, replacing the control data stored in the memory with the new control data.

6. The storage medium according to claim 1, wherein
the transformation is a process of approximating the point cloud data to a normal distribution function.

7. The storage medium according to claim 1 further storing
a moving control program including in the data update program, wherein
the moving control program causes the computer to perform
performing movement control of the moving body based on the control data, and wherein
when the control data has been updated, the performing of the movement control includes performing the movement control based on the control data after the updating.

8. A data update apparatus comprising:
a microprocessor; and
a memory connected to the microprocessor, wherein
the microprocessor is configured to perform:
acquiring point cloud data of an object surface around a moving body obtained by a sensor mounted on the moving body at a predetermined cycle;
generating control data to be used for movement control of the moving body by performing a transformation in which the point cloud data is transformed into a predetermined data format;
storing the control data in a memory connected to the computer; and
updating the control data stored in the memory based on new point cloud data acquired, wherein
the microprocessor is configured to perform
the updating including transforming the new point cloud data into the predetermined data format to generate new control data, and updating the control data stored in the memory based on the new control data.
